(19) United States
(12) Patent Application Publication
(10) Pub. No.: US 2025/0282955 A1
(43) Pub. Date: Sep. 11, 2025

(54) COATING COMPOSITION AND ITS USE

(71) Applicant: Ewald Dörken AG, Herdecke (DE)

(72) Inventors: Susanne Walter, Herdecke (DE); Christopher Köster, Herdecke (DE); Ingo Klüppel, Herdecke (DE); Marcel Roth, Düsseldorf (DE)

(73) Assignee: Ewald Dörken AG, Herdecke (DE)

(21) Appl. No.: 19/067,513

(22) Filed: Feb. 28, 2025

(30) Foreign Application Priority Data
Mar. 5, 2024 (EP) 24161597.0

(51) Int. Cl. C09D 1/04; C08K 3/08; C09D 7/20; C09D 7/61; C23F 13/02

(52) U.S. Cl. CPC C09D 1/04; C08K 3/08; C09D 7/20; C09D 7/61; C23F 13/02; C08K 2003/0893

(57) ABSTRACT

Aqueous coating compositions comprising at least 30 wt. % metal particles, based on the coating composition. The coating composition comprises a silicate-based binding agent. The silicate-based binding agent comprises a silane-modified silicate. The silane-modified silicate is obtained by hydrolysis of a silane in the presence of a silicate at a basic pH.

### CROSS REFERENCE TO RELATED APPLICATION

This application claims the benefit of European Patent Application No. EP24161597.0, filed Mar. 5, 2024, which is incorporated herein by reference in its entirety.

### FIELD

The present invention relates to the technical field of coatings, in particular aqueous coating compositions.

### SUMMARY

Certain aspects of the present disclosure generally relate aqueous coating compositions. In certain examples, the aqueous coating compositions comprise corrosion protection coatings. In further examples, the aqueous coating compositions comprise an anti-corrosion coating.

Other aspects of the present disclosure generally relate to coatings comprising aqueous coating compositions according to the present disclosure.

Other aspects of the present disclosure generally relate to substrates coated with aqueous coating compositions according to the present disclosure.

Other aspects of the present disclosure relates to methods for using and/or producing aqueous coating compositions according to the present disclosure.

It should be recognized that the different aspects described throughout this disclosure may be combined in different manners, including those than expressly disclosed in the provided examples, while still constituting an invention accord to the present disclosure. Various other features, objects and advantages of the disclosure will be made apparent from the following description taken together with the drawings.

### DETAILED DESCRIPTION

Coatings are used as protective or decorative coverings on a variety of articles and for a variety of applications. One special aspect, particularly in the case of technical articles, is protection against corrosion.

Corrosion phenomena on metals are observed in all fields of technology and are of great importance, since the durability or service life of machines, vehicles, industrial plants or even buildings is often decisively dependent on the corrosion properties of the metals used. Corrosion means that metal parts have to be replaced or repaired, which is always associated with a compound of time, material and costs.

According to DIN ISO 8044, corrosion is the physicochemical interaction between a metal and its environment that results in a change in the metal's properties and can lead to significant impairment of the functions of the metal, the environment or the technical system in which the metal is used. Corrosion of metals is usually an electrochemical process, namely the oxidation of metals by atmospheric oxygen, possibly in the presence of electrolyte solutions, with the formation of metal oxide layers.

Since corrosion processes often determine the durability or service life of metals or metal components, it is necessary to reduce the susceptibility and rate of corrosion of metals. To protect metals from corrosion, passive systems—for example coatings such as protective varnishes—are used to protect the metal from environmental influences and thus from corrosion. On the other hand, active systems are also used in which the metal to be protected is used as a cathode, utilizing electrochemical curtains, thus preventing oxidation of the metal or reducing metal ions that have formed. Cathodic corrosion protection can be obtained by applying an external electrical voltage, but it is also possible to bring the protective metal into electrical contact with a less noble metal, i.e. a metal with a lower, i.e. more negative electrochemical standard potential. The two metals then form an electrochemical system in which the less noble metal represents the anode, the so-called sacrificial anode, and is oxidized, while the more noble metal is the cathode at which it is reduced.

A common form of cathodic corrosion protection is the coating of metals or metal components with a less noble metal. In particular, when it comes to corrosion protection for steel, galvanization, i.e. a coating based on zinc or zinc alloys, is often used.

In the galvanization process, steel, in particular sheet steel, is usually coated with elemental zinc by immersion in baths of molten zinc in a hot-dip galvanizing process.

In addition, it is also possible to galvanize steel sheets or steel components electrolytically or galvanically by applying an external voltage to electrolyte baths containing zinc ions.

A special case of galvanization is the use of coatings containing zinc pigments, in particular zinc lamellar coatings, also known as zinc lamellar primers. Zinc lamellar coatings or zinc lamellar primers contain zinc lamellae, i.e. platelet-shaped zinc pigments, in a predominantly inorganic binding agent. The mixture of binding agent and zinc flakes is applied as a dispersion to the metal part to be protected and the binding agent is then cross-linked, whereby a closed, homogeneous layer with a thickness of 5 to 15 μm is obtained. Despite the zinc particles being embedded in a binder matrix, zinc lamellar coatings comprise electrical conductivity and thus ensure a high level of protection. In particular, in the salt spray test at the scribe according to DIN ISO 9227, zinc lamellar coatings with comparable layer thicknesses show significantly improved corrosion resistance compared to both hot-dip galvanized and electroplated or electrolytically galvanized metal parts.

The predominantly inorganic matrix of zinc flake coatings or primers, in which the zinc flakes are embedded, usually consists mainly of silicon dioxide or titanium dioxide. Typical zinc flake coatings, which are applied in the form of the corresponding coating composition on a substrate, are described, for example, in WO 2007/130838 A2 (which is incorporated by reference herein in its entirety).

Zinc lamellar primers are usually formulated as solvent-based systems. On the one hand, the use of organic solvents ensures that moisture-curing systems can be used, i.e. coating compositions that crosslink and cure rapidly on contact with moisture, in particular from the ambient air. On the other hand, the solvent can be completely removed even at low temperatures or at higher temperatures for only a short time. However, solvent-based systems are unfavorable from an environmental and health perspective due to the potential environmental and health hazards from the perspective of occupational safety and environmental protection and are subject to increasingly stringent regulatory requirements.

Water-based coating systems are an environmentally friendly alternative to solvent-based coating systems. While water is unobjectionable from an occupational safety and environmental protection perspective, it often has a lower volatility and higher boiling point than organic solvents, which can be disadvantageous during the drying process. Furthermore, the moisture-induced hardening and cross-linking established in the field of zinc lamellar primers is not possible in aqueous systems. Rather, the film is usually obtained by a thermally induced condensation of titanates and silicates or silane-based compounds and thus by comparatively slow condensation reactions that only take place at higher temperatures. The use of water-based systems is therefore significantly more energy and time consuming than the use of solvent-based systems.

Furthermore, the presence of anti-corrosion pigments, in particular zinc pigments, further limits the application possibilities of water-based coating compositions. In particular, zinc-based anticorrosive pigments are not stable in either an acidic or alkaline environment but tend to form hydrogen and white rust due to the amphoteric behavior of zinc and the lack of passivation. In particular, hydrogen evolution leads to instability of the coating composition, which as a result often has only a short pot life and cannot be stored for a longer period.

The problem arises in particular with the use of silicate-based binder systems based on water glass, since silicates are only stable in an alkaline environment. When the pH value shifts into the neutral or even acidic pH range, they precipitate as silicic acids in the form of amorphous solids, rendering the coating composition unusable. While it is possible to produce colloidal silicic acids that are stable when used in an acidic environment, the process of obtaining these compounds is, however, complex and costly, and the pH value can only be set to a limited extent afterwards, as condensation reactions may otherwise be triggered in the coating composition. Furthermore, zinc particles or particles containing zinc are not stable in a strongly alkaline or acidic environment. These disadvantages hinder the use of aqueous coating compositions and, in particular, the large-scale use of inexpensive water glasses for producing binding agents for cathodic corrosion protection coatings.

The state of the art thus continues to lack an easily accessible and inexpensive binder system that is water-based and into which anticorrosive pigments can be incorporated in a stable manner over a period of months.

Furthermore, the state of the art lacks a binder system that enables a simplified provision of zinc lamellar primers.

One object of the present invention is thus to avoid, or at least mitigate, the aforementioned disadvantages and problems associated with the prior art.

Another object of the present invention is to provide a water-based binder system into which pigments, in particular corrosion protection pigments, can be incorporated with long-term stability.

Many aspects are provided within the present disclosure, which include various embodiments of aqueous coating compositions, methods for making and/or using aqueous coating compositions according the present disclosure, coatings and substrates that include aqueous coating compositions according the present disclosure, and others. Examples of these different aspects are provided herein.

It should be understood that special features, characteristics, configurations and embodiments, as well as advantages or the like, which are explained below—for the purpose of avoiding unnecessary repetitions—may be disclosed only with regard to one aspect of the invention, but naturally apply accordingly with regard to the other aspects of the invention, without the need for an explicit mention.

In addition, it should be noted that, in the context of the present invention, all of the relative or percentage, in particular weight-related, quantity data given below are to be selected by the person skilled in the art in such a way that the sum of the ingredients, additives or similar always adds up to 100% or 100 wt. %. However, this goes without saying for the person skilled in the art. Likewise, aspects referred to as being preferred are non-limiting.

In addition, all the parameter data or the like mentioned in the following can be determined or ascertained in principle using standardized or explicitly stated methods of determination or using methods of determination that are familiar to those skilled in the art.

That having been said, the subject-matter of the present invention will be explained in more detail below.

The subject-matter of the present invention—according to a first aspect of the present invention—is thus an aqueous coating composition comprising at least 30% by weight of metal particles, based on the coating composition, wherein the coating composition comprises a silicate-based binder, wherein the silicate-based binder comprises a silane-modified silicate, wherein the silane-modified silicate is obtained by hydrolysis of a silane in the presence of a silicate at a basic pH.

In the context of the present invention, it is usually envisaged that the silicate-based binding agent or the silane-modified silicate is obtained by at least partial hydrolysis and optionally at least partial condensation of at least one silane in the presence of at least one silicate at a basic pH. Preferably, the silane is completely hydrolyzed.

By at least partially, preferably completely, hydrolyzing the silane in the presence of the silicate, the silane-modified silicate is obtained.

Preferably, the silane-modified silicate is the silicate-based binding agent, or the silicate-based binding agent consists of the silane-modified silicate.

According to a preferred embodiment of the present invention, it is provided that the silicate-based binding agent or the silane-modified silicate is obtained by hydrolysis and at least partial condensation of a silane in the presence of a silicate at a basic pH.

Through the use of a silane-modified silicate in or as a silicate-based binding agent, it is possible to obtain aqueous coating compositions whose pH value can be set flexibly. Surprisingly, it has been shown that after hydrolysis and optionally condensation of the silane in the presence of a silicate at a basic pH value, the resulting silane-modified silicate is stable even at pH values in the neutral range or even in the acidic range and does not precipitate, as is the case with water glasses, for example.

The coating composition according to the invention thus offers the possibility of providing an aqueous coating composition, in particular for cathodic corrosion protection coatings, whose pH value can be adjusted in such a way that pigments, in particular also zinc-containing pigments, can be stored stably in an aqueous coating composition without complex treatment, for example using a coating.

By stable is meant that the coating composition does not change in its chemical and/or physical properties or at least does not change significantly and that, in particular, no gas evolution occurs. In the context of the invention, it is preferably provided that the coating composition is stable over a period of at least 10 days, preferably at least 14 days, preferably at least 28 days.

Similarly, it may be envisaged within the scope of the present invention that the coating composition is stable over a period of 10 days to 4 months, in particular 14 days to 3 months, preferably 1 month to 2 months.

In the context of the present invention, a silane-modified silicate is to be understood as a silicate in the presence of which at least one silane has been at least partially hydrolyzed and optionally condensed. The nature of the interaction between hydrolyzed silane and silicate has not yet been clarified. However, the hydrolyzed silane appears to bind at least partially to the silanol functions of the silicate. The interaction between silane and silicate is shown in particular by the fact that solutions of the silane-modified silicate can be acidified without any problems, while amorphous solids are precipitated from basic solutions of silicates, in particular water glasses, during acidification. Mixtures of pre-condensed silanes and silicates also do not exhibit the behavior of the silane-modified silicates used according to the invention, but also lead to the production of precipitates during acidification.

The metal particles used in the context of the present invention are in particular pigments, preferably anti-corrosion pigments, such as zinc dust or zinc flakes or zinc alloy flakes.

The aqueous coating composition according to the invention is preferably a coating composition for producing cathodic corrosion protection coatings.

In the context of the present invention, a binding agent, also known as a binder, is understood to be a substance or a combination of different substances which is capable of binding further components of the coating composition and producing compounds to the substrate. In general, binding agents are substances that produce or promote chemical bonds at the phase boundaries of other substances or trigger or increase effects such as cohesion, adsorption and adhesion or friction. They combine substances by absorbing, attaching, holding together, cross-linking or bonding them.

In the context of the present invention, it is usually provided that the pH of the coating composition is adjustable in the range from pH 1 to pH 14.

In the context of the present invention, it is in particular envisaged that the coating composition comprises a pH value in the range from 1 to 14, in particular 2 to 13, preferably 3 to 12, preferably 4 to 11. The pH of the coating composition according to the invention can be specifically adjusted to the other components of the coating composition, such as fillers, co-binding agents or metal pigments, due to the use of the silane-modified silicate. In particular, it is possible to adjust the pH value to the redox potential of the metal particles used or the formation of passivation layers on the metal particles, so that these can be stored stably in the coating composition over a long period of time. This is important and advantageous in particular for the use of zinc-containing particles in aqueous systems, which otherwise tend to develop hydrogen, ultimately rendering the coating composition unusable.

The use of silane-modified silicate compounds or silane-modified water glasses also means that no carbonation is observed if the pH value of the coating composition is set to values less than or equal to 9, preferably less than or equal to 8.5, wherein the silicate does not precipitate despite the lowering of the pH value. The pH adjustment can be effected by adding acids. Use of the silane-modified silicate compounds or the silane-modified water glasses in the neutral or acidic pH range is preferred, especially since the absorption of carbon dioxide in the form of carbonates is significantly reduced in the acidic range.

However, it is particularly preferred within the scope of the present invention if the coating composition comprises a pH value in the range of 7 to 9, in particular 8 to 9. In this pH range, metal particles containing aluminum and zinc are passivated and carbonation, which adversely affects the appearance and feel of the coating, is reliably prevented.

In particular, the pH value adjustment can be effected by adding organic and/or inorganic acids, preferably inorganic acids. It has proved well if the acid is selected from the group of phosphoric acid, phosphonic acid, organic phosphonic acids, nitric acid, sulphuric acid, acetic acid, citric acid, propanoic acid, acrylic acid, oxalic acid, fumaric acid, benzoic acid, succinic acid, maleic acid, salicylic acid, aminosalicylic acid, nicotinic acid, formic acid, malic acid, tartaric acid, ascorbic acid, propanoic acid, lactic acid, phthalic acid and mixtures thereof, in particular phosphoric acid, phosphonic acid, organic phosphonic acids, nitric acid, sulphuric acid, acetic acid, citric acid, propanoic acid, and mixtures thereof, preferably phosphoric acid, phosphonic acid, organic phosphonic acids, nitric acid and mixtures thereof, preferably phosphoric acid, phosphonic acid, organic phosphonic acids and mixtures thereof.

As far as the amount of metal particles in the coating composition is concerned, this can naturally vary over a wide range. However, it proved well if the coating composition comprises the metal particles in amounts of more than 32 wt. %, in particular more than 34 wt. %, preferably more than 40 wt. %, more preferably more than 45 wt. %, based on the coating composition.

Similarly, it may be envisaged that the coating compositions comprise the metal particles in amounts of 30 to 95 wt. %, in particular 32 to 90 wt. %, preferably 34 to 90 wt. %, more preferably 40 to 85 wt. %, particularly preferred 45 to 80 wt. %, based on the coating composition. In the context of the present invention, very large proportions of metal particles, in particular metal pigments, can thus be present in the composition.

The metal particles, in particular metal pigments, can be selected from all conceivable metal particles. For example, anti-corrosion pigments, but also effect pigments are conceivable. In the context of the present invention, anti-corrosion pigments are preferably used. It is specially well proven if the metal particles are selected from particles, in particular pigments, of iron, nickel, chromium, magnesium, aluminum, zinc and mixtures and alloys thereof. According to a preferred embodiment of the present invention, the metal particles are selected from particles, in particular pigments, of magnesium, aluminum, zinc and mixtures and alloys thereof.

It is particularly preferred in the context of the present invention if the metal particles are selected from particles, in particular pigments, of zinc, zinc alloys and mixtures thereof. The use of zinc alloys is particularly preferred in the context of the present invention.

If metal particles based on zinc alloys are used, the zinc alloys are usually selected from zinc-bismuth alloys, zinc-aluminum alloys and/or zinc-aluminum-magnesium alloys. In this context, it is particularly preferred if the zinc alloys are selected from zinc-aluminum alloys and/or zinc-aluminum-magnesium alloys. The best results are obtained if the zinc alloy is a zinc-aluminum-magnesium alloy.

As far as the type of particles is concerned, these can be selected from any suitable metal particles. However, it is well proven if the metal particles are selected from platelet-shaped, grain-shaped, in particular spherical, metal particles and mixtures thereof.

According to a preferred embodiment, it is provided in this context that the coating composition comprises only granular, in particular spherical, metal particles, in particular as anti-corrosion pigments.

If the coating composition comprises granular, in particular spherical, metal particles, it proved well if the coating composition comprises the metal particles in amounts of more than 55 wt. %, in particular more than 60 wt. %, preferably more than 65 wt. %, more preferably more than 70 wt. %, based on the coating composition.

Similarly, it may be envisaged that the coating compositions comprise the metal particles in amounts of 50 to 95 wt. %, in particular 55 to 90 wt. %, preferably 60 to 90 wt. %, more preferably 65 to 85 wt. %, particularly preferred 70 to 80 wt. %, based on the coating composition.

According to a further preferred embodiment of the present invention, the first layer comprises platelet-shaped and grain-shaped, in particular spherical, metal particles. Through the use of platelet-shaped and grain-shaped, in particular spherical, metal particles, the corrosion protection effect of the cathodic corrosion protection coatings can be significantly improved again, since platelet-shaped metal particles, the so-called lamellae, ensure significantly improved corrosion protection. However, the viscosity of the coating composition rises sharply as the proportion of platelet-shaped metal particles, i.e. lamellae, increases.

If the coating composition comprises both platelet-shaped and grain-shaped, in particular spherical, metal particles, it is well proven if the coating composition comprises a weight-related ratio of platelet-shaped to grain-shaped metal particles in the range from 19:1 to 1:19, in particular 10:1 to 1:15, preferably 1:1 to 1:12, more preferably 1:2 to 1:10, particularly preferred 1:3 to 1:9. Preferably, the coating composition thus comprises a high proportion of, in particular, granular, preferably spherical, metal particles.

According to another preferred embodiment of the present invention, the coating composition comprises platelet-shaped metal particles. In particular, the coating composition according to this embodiment of the present invention preferably comprises platelet-shaped metal particles alone as anti-corrosion pigments. Since the use of platelet-shaped metal particles, or lamellae, is associated with a strong increase in viscosity with the coating composition, such coating compositions comprise a proportion of metal particles in the range from 30 to 70 wt. %, in particular 32 to 65 wt. %, preferably 34 to 60 wt. %, based on the coating composition.

Platelet-shaped metal particles are also called flakes or lamellae in common parlance. Platelet-shaped metal particles comprise a significantly smaller expansion in one spatial direction, which is referred to below as the thickness; the expansion in the other two spatial directions is referred to below as the diameter. In particular, platelet-shaped metal particles comprise at least one main direction of expansion. Grain-shaped metal particles are irregularly shaped metal particles, whereas spherical metal particles are approximately spherical in shape. The use of spherical metal particles is usually preferable to the use of grain-shaped metal particles.

In particular, good results are obtained when spherical or grain-shaped metal particles are made of pure zinc and platelet-shaped metal particles are made of zinc alloys.

As far as the dimensioning of the metal particles is concerned, this can vary over a wide range.

It is generally envisaged that the platelet-shaped metal particles comprise a thickness of 50 to 1,000 nm, in particular 60 to 750 nm, preferably 80 to 600 nm, more preferably 100 to 500 nm.

Similarly, it may be provided that the platelet-shaped metal particles comprise a diameter, in particular a length along their main direction of expansion, of 1 to 25 μm, in particular 2 to 20 μm, preferably 5 to 18 μm, more preferably 5 to 15 μm.

In addition, it may be provided that the platelet-shaped metal particles comprise a particle size distribution D50 of 8 to 20 μm, in particular 10 to 16 μm. Furthermore, it is possible that the platelet-shaped metal particles comprise a particle size distribution D90 of 20 to 30 μm, in particular 22 to 28 μm.

If grain-shaped, in particular spherical, metal particles are used in the context of the present invention, it is well proven if the metal particles comprise diameters in the range from 500 nm to 20 μm, in particular 500 nm to 10 μm, preferably 500 nm to 5 μm.

In addition, it may be provided that the grain-shaped, in particular spherical, metal particles comprise a particle size distribution D50 of 1 to 10 μm, in particular 2 to 8 μm. Furthermore, it is possible that the grain-shaped, in particular spherical, metal particles comprise a particle size distribution D90 of 6 to 20 μm, in particular 8 to 17 μm.

In the context of the present invention, it is usually envisaged that the silicate of the silicate-based binding agent or the silane-modified silicate is a water glass.

In the context of the present invention, it is preferably if the water glass is selected from the group of lithium water glass, sodium water glass, potassium water glass and mixtures thereof. Particularly good results are obtained in the context of the present invention if the water glass is selected from the group of sodium water glass, potassium water glass and mixtures thereof. It is particularly preferred within the scope of the present invention if the water glass is potassium water glass.

As far as the silane used is concerned, this can also be selected from a large number of suitable silanes. In the context of the present invention, however, it is well proven if the silane of the silicate-based binding agent or the silane-modified silicate is selected from the group of epoxy-functional silanes, phenoxy-functional silanes, vinyl-functional silanes, amino-functional silanes and mixtures thereof, preferably epoxy-functional silanes, amino-functional silanes and mixtures thereof.

Furthermore, in the context of the present invention, it is preferably provided that the silane comprises at least one hydrolyzable chemical group, preferably a hydrolyzable chemical group directly bonded to the silicon. The hydrolyzable chemical group is preferably selected from alkoxy groups, carboxy groups, halides and mixtures thereof. Preferably, the hydrolyzable chemical group is selected from the group of methoxy group, ethoxy group, propoxy group, iso-propoxy group, butoxy group, acetoxy, chloride and mixtures thereof, in particular methoxy group, ethoxy group and mixtures thereof.

In particular, the aforementioned silanes allow good adhesion both to the substrates used and to any other layers to be applied.

In the context of the present invention, it has proved particularly well if the silane is selected from the group of methacryloxymethyltrimethoxysilane, methacryloxy-methyltriethoxysilane, 3-aminopropylmethyldimethoxysilane, 3-aminopropyltriethoxysilane, N-(2-aminoethyl)-3-aminopropylmethyldimethoxysilane, 3-mercaptopropyltrimethoxysilane, N-(2-aminoethyl)-3-aminopropyltrimethoxysilane, N-(2-aminoethyl)-3-aminopropyltrimethoxysilane, N-cyclohexyl-3-aminopropyltrimethoxysilane, N-cyclohexylaminomethyltriethoxysilane, 3-aminopropyltriethoxysilane, 3-(2-aminomethylamino)propyltriethoxysilane, N-(2-aminoethyl)-3-aminopropylmethyl-dimethoxysilane, 3-aminopropyltrimethoxysilane, 3-ureidopropyltrimethoxysilane, vinyltrimethoxysilane, vinyl dimethoxymethylsilane, vinyltriethoxysilane, vinyltriacetoxy-silane, 3-methacryloxypropyltrimethoxysilane, methacryloxymethyl)methyldimethoxysilane, methacryloxymethyltrimethoxysilane, 3-methacryloxypropyltriacetoxysilane, N-methyl [3-(trimethoxysilyl)propyl]carbamate, N-trimethoxysilylmethyl-O-methylcarbamate, N-dimethoxy(methyl)silylmethyl-O-methylcarbamate, tris-[3-(trimethoxysilyl)propyl]isocyanurate, 3-glycidoxypropyltrimethoxysilane, 3-glycidoxypropyltriethoxysilane, methyltrimethoxysilane, methyltriethoxysilane, dimethyl-dimethoxysilane, dimethyldiethoxysilane, trimethylethoxysilane, isooctyltrimethoxysilane, isooctyltriethoxysilane, hexadecyltrimethoxysilane, (cyclohexyl) methyldimethoxysilane, dicyclopentyldimethoxysilane, phenyltriethoxysilane, triacetoxyethylsilane, 1,2-bis(triethoxysilyl)ethane and mixtures thereof.

Particularly good results are obtained when the silane is selected from the group of 3-aminopropylmethyldimethoxysilane, 3-aminopropyltriethoxysilane, N-(2-aminoethyl)-3-aminopropylmethyldimethoxysilane, N-(2-aminoethyl)-3-aminopropyltrimethoxysilane, N-(2-aminoethyl)-3-aminopropyltriethoxysilane, N-cyclohexyl-3-aminopropyltrimethoxysilane, N-cyclohexylaminomethyltriethoxysilane, 3-aminopropyltriethoxysilane, 3-(2-aminomethylamino)propyltriethoxysilane, N-(2-aminoethyl)-3-aminopropylmethyldimethoxysilane, 3-aminopropyltrimethoxysilane, glycidoxy-propyltrimethoxysilane, 3-glycidoxypropyltriethoxysilane and mixtures thereof, preferably N-(2-aminoethyl)-3-aminopropyltrimethoxysilane, N-(2-aminoethyl)-3-aminopropyltriethoxysilane, glycidoxypropyltrimethoxysilane, 3-glycidoxy-propyltriethoxysilane and mixtures thereof.

In the context of the present invention, it is usually envisaged that the coating composition comprises the silicate-based binding agent in amounts of 1 to 30 wt. %, in particular 1 to 20 wt. %, preferably 2 to 15 wt. %, more preferably 3 to 10 wt. %, particularly preferred 4 to 8 wt. %, based on the coating composition.

Similarly, it may be provided that the coating composition comprises the silicate-based binding agent in amounts of at least 1 wt. %, in particular at least 2 wt. %, preferably at least 3 wt. %, more preferably at least 4 wt. %, based on the coating composition.

In addition, it may also be provided that the coating composition comprises the silicate-based binding agent in amounts of at most 30 wt. %, in particular at most 20 wt. %, preferably at most 15 wt. %, more preferably at most 10 wt. %, particularly preferred at most 8 wt. %, based on the coating composition.

According to a further preferred embodiment of the present invention, it may be provided that the composition comprises at least one further binding agent.

The further binding agent can be an inorganic and/or an organic binding agent. Preferably, however, an organic binding agent is used as the further binding agent in the context of the present invention.

In particular, binding agents based on silanes, silicates, silicic acids or even titanates can be used as inorganic binding agents.

In the context of the present invention, it is well proven if the further, in particular organic, binding agent comprises an organic polymer. Preferably, the further, in particular organic, binding agent comprises the organic polymer. It is well proven if the organic polymer is selected from the group of acrylates, styrene-acrylate copolymers, polyurethanes, polyvinyl acetate, polyvinyl alcohol, ethyl cellulose, carboxymethyl cellulose, polyvinyl pyrrolidone, polyvinyl butyral and mixtures and copolymers thereof. Preferably, the polymer is selected from the group of acrylates, styrene-acrylate copolymers, polyurethanes, polyvinyl acetate, polyvinyl alcohol and mixtures and copolymers thereof.

Preferably, the polymer is selected from the group of acrylates, polyurethanes and mixtures thereof and copolymers, in particular acrylates and acrtylate copolymers. Special good results are obtained in the context of the present invention if the polymer is an acrylate.

In the event that the coating composition comprises a further binding agent, it is usually provided that the coating composition comprises the further binding agent in amounts of 1 to 20 wt. %, in particular 1 to 15 wt. %, preferably 2 to 10 wt. %, more preferably 3 to 8 wt. %, particularly preferred 3 to 7 wt. %, based on the coating composition.

Similarly, it may be envisaged in the context of the present invention that the coating composition comprises the further binding agent in amounts of at least 1 wt. %, in particular at least 2 wt. %, preferably at least 3 wt. %, based on the coating composition.

In addition, however, it is also possible for the coating composition to comprise the further binding agent in amounts of at most 20 wt. %, in particular at most 15 wt. %, preferably at most 10 wt. %, more preferably at most 8 wt. %, particularly preferred at most 7 wt. %, based on the coating composition.

As previously configured, the coating composition according to the invention is an aqueous coating composition.

The proportion of water contained in the coating composition can vary over a wide range depending on the type of metal particles used and the intended application. Typically, the coating composition contains water in amounts of at least 3 wt. %, in particular at least 5 wt. %, preferably at least 7 wt. %, more preferably at least 8 wt. %, particularly preferred at least 10 wt. %, based on the coating composition.

Furthermore, it may be provided that the coating composition comprises water in amounts of up to 40 wt. %, in particular up to 30 wt. %, preferably up to 25 wt. %, more preferably up to 20 wt. %, based on the coating composition.

According to a preferred embodiment of the present invention, it is provided that the coating composition comprises water in amounts of 3 to 40 wt. %, in particular 5 to 30 wt. %, preferably 7 to 25 wt. %, more preferably 8 to 20 wt. %, particularly preferably 10 to 20 wt. %, based on the coating composition.

Furthermore, it is also possible that the coating composition comprises at least one additive.

If the coating composition comprises an additive, it is well proven if the coating composition comprises the additive in amounts of 0.1 to 10 wt. %, in particular 0.2 to 8 wt. %, preferably 0.3 to 5 wt. %, more preferably 0.5 to 2 wt. %, particularly preferred 0.7 to 1.5 wt. %, based on the coating composition.

Particularly good results are obtained in the context of the present invention if the additive is selected from the group of thickeners, rheology adjusting agents, wetting agents, preservatives, stabilizers, acids and/or bases, defoaming components, film formers, levelling agents, UV absorbers, fillers, pH stabilizers, pH adjusting agents and mixtures thereof.

According to a preferred embodiment of the present invention, the aqueous coating composition thus comprises
a. a silicate-based binding agent, in particular in amounts of 1 to 30 wt. %,
b. metal particles, in particular in amounts of at least 30 wt. %, preferably in amounts of 30 to 95 wt. %,
c. water, in particular in amounts of 3 to 40 wt. %, and
d. at least one additive, in particular in amounts of 0.1 to 10 wt. %,
   in relation to the coating composition.

All features, special features and advantages previously described in the context of the other embodiments apply accordingly to this embodiment.

Furthermore, it may be provided that the coating composition contains at least one lubricant. Through the use of a lubricant, the coefficient of friction of the resulting coating can be set in a targeted manner.

In the context of the present invention, special results are obtained if the lubricant is selected from the group of waxes, plastic particles, in particular polyether ketone (PEK), polyether ether ketone (PEEK), polyphenylene sulfide (PPS), polyethersulfone (PES), polyetherimide (PEI), polyamideimide (PAI), polytetrafluoroethylene (PTFE), polyvinylidene fluoride (PVDF) and mixtures thereof, micronized sulfur and mixtures thereof, in particular selected from the group of waxes, plastic particles, in particular polyether ketone (PEK), polyether ether ketone (PEEK), polyphenylene sulfide (PPS), polyether sulfone (PES), polyetherimide (PEI), polyamideimide (PAI) and mixtures thereof, micronized sulfur and mixtures thereof. Special good results are obtained in the context of the present invention if the lubricant is a wax.

If the lubricant is a wax, it is well proven if the wax is selected from the group of natural waxes, semi-synthetic waxes, synthetic waxes and mixtures thereof. Preferably, the wax is a synthetic wax.

Similarly, it is preferred in the context of the present invention if the wax is selected from the group consisting of beeswax, carnauba wax, montan wax, modified montan wax, amide wax, polypropylene wax, polyethylene wax, HDPE wax (high-density polyethylene wax), oxidized HDPE wax, ethylene-vinyl acetate wax, polyethylene glycol wax, polyester wax, Fischer-Tropsch wax and mixtures thereof, preferably polypropylene wax, polyethylene wax, HDPE wax, oxidized HDPE wax, ethylene-vinyl acetate wax, polyethylene glycol wax, polyester wax, Fischer-Tropsch wax and mixtures thereof.

Special good results are obtained in this context if the wax is selected from the group of polypropylene wax, polyethylene wax, HDPE wax, oxidized HDPE wax, Fischer-Tropsch wax and mixtures thereof.

Even more preferably, in the context of the present invention, if the wax is a polyethylene wax (PE wax).

Furthermore, it is preferred within the scope of the invention if the coating composition contains the lubricant in amounts of 1 to 15 wt. %, in particular 2 to 12 wt. %, preferably 3 to 10 wt. %, more preferably 4 to 8 wt. %, based on the coating composition.

According to a preferred embodiment of the present invention, it is thus provided that the coating composition comprises
a. a silicate-based binding agent, in particular in amounts of 1 to 30 wt. %,
b. metal particles, in particular in amounts of at least 30 wt. %, preferably in amounts of 30 to 95 wt. %,
c. water, in particular in amounts of 3 to 40 wt. %,
d. at least one additive, in particular in amounts of 0.1 to 10 wt. %, and
e. at least one lubricant, in particular in amounts of 1 to 15 wt. %,
in each case based on the coating composition.

All features, special features and advantages previously described in the context of the other embodiments apply accordingly to this embodiment.

According to a further preferred embodiment of the present invention, it is provided that the coating composition comprises at least one filler.

According to a particularly preferred embodiment of the present invention, the filler is a platelet-shaped filler. Platelet-shaped fillers in particular, when used with platelet-shaped metal pigments, lead to particularly uniform surfaces and also enable the friction coefficient of the resulting coating to be specifically set. It is particularly preferred that the friction coefficient of the coating is set by the coating composition containing a lubricant and a platelet-shaped filler.

If the coating composition comprises a filler, it is usually provided that the coating composition comprises the filler in amounts of 0.1 to 25 wt. %, in particular 1 to 20 wt. %, preferably 3 to 20 wt. %, more preferably 5 to 15 wt. %, particularly preferred 8 to 15 wt. %, based on the coating composition.

In the context of the present invention, it is well proven if the filler is selected from the group of mica, talc, phyllosilicates and mixtures thereof.

According to a preferred embodiment of the present invention, it is thus provided that the coating composition comprises
a. a silicate-based binding agent, in particular in amounts of 1 to 30 wt. %,
b. metal particles, in particular in amounts of at least 30 wt. %, preferably in amounts of 30 to 95 wt. %,
c. water, in particular in amounts of 3 to 40 wt. %,
d. at least one additive, in particular in amounts of 0.1 to 10 wt. %,
e. at least one lubricant, in particular in amounts of 1 to 15 wt. %, and
f. at least one filler, in particular in amounts of 0.1 to 25 wt. %,
in each case based on the coating composition.

All features, special features and advantages previously described in the context of the other embodiments apply accordingly to this embodiment.

Furthermore, the coating composition preferably comprises only small amounts of organic solvents and volatile organic compounds (VOCs). Typically, the coating composition contains organic solvents and volatile organic compounds in amounts of less than 3 wt. %, in particular less than 1 wt. %, preferably less than 0.5 wt. %, more preferably less than 0.3 wt. %, particularly preferred less than 0.1 wt. %, based on the coating composition. Preferably, the coating composition is free of organic solvents and volatile organic compounds.

As far as the viscosity of the coating composition according to the invention is concerned, this can vary over a wide range. However, particularly good results are obtained in the context of the present invention if the coating composition comprises a dynamic viscosity at 20° C. according to Brookfield in the range of 2 to 5,000 mPas, in particular 5 to 1,000 mPas, preferably 5 to 500 mPas, preferably 10 to 100 mPas, in particular preferably 30 to 50 mPas. The viscosity can be determined in particular according to ISO 2431.

Again, a further subject-matter of the present invention-according to a second aspect of the present invention-is the use of a previously described aqueous coating composition for producing a corrosion protection coating, in particular a cathodic corrosion protection coating.

As already explained above, the coating composition according to the invention is excellently suited for producing cathodic corrosion protection coatings, since it makes it possible in particular to adapt the pH value specifically to the redox potential and the formation of passivation layers of the metal particles used.

For further details of the use according to the invention, reference can be made to the above explanations on the coating composition according to the invention, which apply accordingly with respect to the use according to the invention.

Again, another subject-matter of the present invention-according to a third aspect of the present invention-is a method for coating a substrate, wherein a previously described coating composition is applied on a substrate and subsequently dried.

In the context of the present invention, it is usually envisaged that the substrate comprises a metal, in particular is a metallic substrate.

Furthermore, it is preferred if the metal is selected from the group of iron, aluminum, magnesium and mixtures and alloys thereof.

Particularly good results are obtained if the metal of the substrate is selected from iron and its alloys, in particular a steel.

In the context of the present invention, a substrate is to be understood as any suitable three-dimensional article and any surface to which the coating composition according to the invention can be applied. Preferably, however, the substrate is a subject-matter, in particular a component, to which the coating composition is at least partially applied.

In the context of the present invention, it has furthermore been well proven if the coating composition is applied to the substrate with a layer thickness in the range of 1 to 200 μm, in particular 1 to 150 μm, preferably 2 to 130 μm, particularly preferably 4 to 120 μm, and even more preferably 5 to 120 μm.

According to a preferred embodiment of the invention, the coating composition is applied to the substrate with a layer thickness in the range from 1 to 50 μm, in particular from 1 to 40 μm, preferably from 2 to 30 μm, particularly preferably from 4 to 25 μm, and even more preferably from 5 to 20 μm.

According to a further embodiment of the invention, in particular for producing thick-film coatings, the coating composition is applied to the substrate with a layer thickness in the range from 30 to 200 μm, in particular 40 to 150 μm, preferably 50 to 130 μm, particularly preferably 60 to 120 μm, even more preferably 70 to 120 μm

The coating composition can be applied by any suitable method. Typically, however, the coating composition is applied to the substrate using spraying, brushing, scraping, rolling, dipping or dip spinning. Particularly good results are obtained if the coating composition is applied using spraying, dipping or dip spinning. It is particularly preferred in the context of the present invention if the coating composition is applied to the entire surface of the substrate.

Typically, the coating composition is dried after applying it to the substrate. The temperature at which the coating composition is dried can vary over a wide range depending on the substrate selected.

However, it has been found to be convenient if the coating composition is dried at temperatures in the range of 5 to 300° C., in particular 10 to 250° C., preferably 15 to 200° C., preferably 20 to 150° C.

Similarly, it has been found convenient if the coating composition is dried for a period of time ranging from 1 minute to 30 hours, in particular 5 minutes to 20 hours, preferably 10 minutes to 16 hours.

In the context of the present, it is preferred if the coating composition is dried at approximately room temperature, i.e. at about 25° C., in particular at temperatures in the range from 10 to 40° C., in particular 15 to 35° C., preferably 20 to 30° C. In this case, the drying times are usually in the range of 1 to 30 hours, in particular 5 to 20 hours, preferably 8 to 16 hours.

For further details of the method according to the invention for coating a substrate, reference can be made to the previous configurations of the further aspects of the invention, which apply accordingly with regard to the method according to the invention.

In addition, a further subject-matter of the present invention-according to a fourth aspect of the present invention-is a coating obtainable by a method described above or with a coating composition described above.

In the context of the present invention, it is usually envisaged that the coating comprises a layer thickness in the range of 1 to 150 μm, in particular 1 to 120 μm, preferably 1 to 110 μm, more preferably 2 to 100 μm, particularly preferred 5 to 100 μm.

According to a preferred embodiment, it is provided that the coating comprises a layer thickness in the range of 1 to 45 μm, in particular 1 to 40 μm, preferably 1 to 35 μm, more preferably 2 to 20 μm, particularly preferred 5 to 15 μm.

However, it is also possible for the coating to be used as a thick film coating. In this case, it is preferable if the coating comprises a layer thickness in the range of 30 to 150 μm, in particular 40 to 120 μm, preferably 50 to 110 μm, more preferably 60 to 100 μm, particularly preferred 70 to 100 μm.

As far as the proportion of metal particles in the coating is concerned, this can vary over a wide range, as is already the case with the coating composition. However, it has been well proven in the context of the present invention if the coating comprises the metal particles in amounts of more than 50 wt. %, in particular more than 60 wt. %, preferably more than 70 wt. %, more preferably more than 80 wt. %, relative to the coating.

Similarly, in the context of the present invention, particularly good results are obtained if the coating comprises the metal particles in amounts of 50 to 99 wt. %, in particular 60 to 98 wt. %, preferably 70 to 98 wt. %, more preferably 80 to 98 wt. %, based on the coating.

Furthermore, it is also possible that the coating comprises the silicate-based binding agent in amounts of 1 to 30 wt. %, in particular 1 to 25 wt. %, preferably 2 to 20 wt. %, more preferably 3 to 15 wt. %, based on the coating.

For further details of the coating according to the invention, reference can be made to the preceding configurations of the other aspects of the invention, which apply accordingly with respect to the coating according to the invention.

Finally, a further subject-matter of the present invention-according to a fifth aspect of the present invention-is a method for producing a coating composition as described above, wherein at least one silane is used in the presence of at least one silicate at a pH equal to or greater than 8.

Typically, it is envisaged in the context of the invention that at least one silane is hydrolyzed in the presence of at least one silicate at a pH equal to or greater than 8, in particular at least partially hydrolyzed, preferably completely hydrolyzed, and optionally in particular at least partially condensed.

Preferably, in the context of the present invention, it is thereby provided that the pH during hydrolysis and optionally condensation of the silane in the presence of at least one silicate is equal to or greater than 9, preferably equal to or greater than 10, preferably equal to or greater than 11.

The hydrolysis and optionally condensation of the silane in the presence of the silicate is performed at temperatures in the range from 10 to 50° C., in particular 10 to 40° C., preferably 15 to 35° C., more preferably 20 to 30° C.

Hydrolysis and optionally condensation is usually carried out by slowly adding the silane or silane mixture to the silicate, usually over several hours, at most up to 12 hours, preferably with constant mixing.

The hydrolysis and optionally condensation is usually carried out over a period of 1 to 60 hours, preferably 12 to 48 hours.

As far as the quantitative ratio of silane to silicate is concerned, it is well proven if silane and silicate are used in a weight ratio of silane to silicate of 2:1 to 1:10, in particular 1:1 to 1:5, preferably 1:1 to 1:3, more preferably 1:1 to 1:2.

According to a particularly preferred embodiment of the present invention, silane and silicate are used in a quantity-related ratio of parts by substance of silane to parts by weight of silicate, calculated as the solids content of the silicate, i.e. mol silane:gram silicate, of 0.009 (mol silane):10 (g silicate) to 0.0045 (mol silane):1 (g silicate), in particular 0.0045:1 to 0.0045:5, preferably 0.0045:1 to 0.0045:3, more preferably 0.0045:1 to 0.0045:2.

According to a preferred embodiment of the present invention, it is provided that after hydrolyzing and optionally condensing the silane in the presence of at least one silicate, the pH is set in the range from 1 to 14, in particular 2 to 13, preferably 4 to 12, preferably 5 to 11.

The pH value adjustment is generally performed by the addition of acid and preferably at temperatures in the range from 10 to 50° C., in particular 10 to 40° C., preferably 15 to 35° C., more preferably 20 to 30° C.

Furthermore, it may be provided within the scope of the present invention that, after hydrolysis and optionally condensation of the silane in the presence of at least one silicate, volatile components are removed from the reaction mixture. The volatile components are, in particular, alcohols which are released during the hydrolysis of the silanes.

Similarly, it may also be provided that the solids content of the silicate-based binding agent is set to at least 10 wt. %, in particular at least 15 wt. %, preferably at least 20 wt. %, based on the silicate-based binding agent.

According to one embodiment of the invention, the method for producing a silane-modified silicate or a silane-modified water glass is carried out in such a way that a silane is at least partially hydrolyzed in the presence of a silicate compound or a water glass at a pH equal to or greater than 8, in particular greater than 11, to give a silane-modified silicate or water glass and the pH is then set to values less than 10, in particular less than 9, preferably in the range from 5 to 9, in particular by adding acid.

Partial hydrolysis of silane and silicate in aqueous alkaline solution can be continued after acidification to a pH value of 7 or less, if desired, up to complete hydrolysis.

Usually, however, the hydrolysis or optionally the condensation of the silane in the presence of the silicate to form a silane-modified silicate compound or a silane-modified water glass is carried out completely in the alkaline.

It is also possible to set a pH value between 2 and 4 during acidification, which can be achieved and maintained without precipitation or flocculation of the silane-modified silicate compound or the silane-modified water glass.

For further details of this method according to the invention for coating a substrate, reference can be made to the previous configurations relating to the further aspects of the invention, which apply accordingly with regard to the method according to the invention.

The subject-matter of the present invention is explained below in a non-limiting manner and purely by way of example with reference to the embodiment examples.

### EXAMPLES

### 1. Production of Binder Systems According to the Invention

To produce the binder systems used in the invention, water-glasses are first provided and then a silane is added. The mixture is stirred for ten hours at room temperature to hydrolyze and optionally condense the silanes. The pH of the mixture can then be specifically adjusted by adding acids.

The alcohol produced during hydrolysis is removed in a rotary evaporator. Also, the solids content of the resulting mixture is set to approx. 50% in the rotary evaporator. An exemplary list of material combinations can be found in Table 1 below.

TABLE 1
Binder mixtures (water glass/silane), partly with a change in pH

| | Binder systems | | |
|---|---|---|---|
| | 1 | 2 | 3 |
| | [parts | [parts | [parts |
| Components | by weight] | by weight] | by weight] |
| Lithium polysilicate¹ | 77.00 | — | — |
| Potassium silicate² | — | 77.00 | 77.00 |
| DAMO³ | 23.00 | 23.00 | 23.00 |
| H₃PO₃ (50%) | — | — | 19.00 |
| Sum: | 100.00 | 100.00 | 119.00 |
| pH: | 12 | 12 | 8.3 |

¹solid content 24 wt.-%
²solid content 21 wt.-%
³2-Aminomethyl-3-aminopropyltriethoxysilane

### 2. Production of a Coating Composition According to the Invention

A corrosion protection coating composition with zinc dust is produced with the binding agent system 2 according to Table 1. The exact composition is shown in Table 2.

For the production, at first the binding agent according to the invention is mixed with demineralized water under stirring, before the other components, namely rheology control agent, filler and zinc dust are added.

TABLE 2
Coating composition according to the invention

| | Amount |
|---|---|
| Components: | [parts by weight] |
| Binding agent 2 | 8.70 |
| Demineralized water | 11.40 |
| Aerosil 200 (silicic acid) | 1.00 |
| Mica MU M2/1 (mica) | 7.90 |
| EverZinc 4P16 (zinc dust) | 71.00 |

### 3. Corrosion Tests

Corrosion protection tests according to DIN EN ISO 9227 are carried out with the coating composition according to the invention.

The coating composition is applied with a layer thickness of approx. 40 μm and dried at 20° C. for 24 hours. After a storage period of one week at ambient conditions, the corrosion protection test is carried out.

The results for several coating processes are shown in Table 3 below.

TABLE 3
Corrosion tests

| | Dry film thickness | Scratch 1 | Scratch 2 |
|---|---|---|---|
| Test no. | [μm] | (h to RRF*) | (h to RRF*) |
| | 30-35 | 1224 | 1224 |
| 2 | 32-36 | 1440 | 1512 |
| 3 | 33-36 | 1440 | 1440 |

*RRF = red rust formation

It can be seen that the coating composition according to the invention comprises excellent corrosion protection properties, wherein it can be processed like conventional cathodic corrosion protection coatings based on zinc dust or zinc lamellae, i.e. in particular by applying it by means of scrapers, spraying or dipping on a substrate.

What is claimed is:

1. An aqueous coating composition comprising at least 30 wt. % metal particles, based on the coating composition, wherein the coating composition comprises a silicate-based binding agent, wherein the silicate-based binding agent comprises a silane-modified silicate, and wherein the silane-modified silicate is obtained by hydrolysis of a silane in the presence of a silicate at a basic pH.

2. The aqueous coating composition according to claim 1, wherein the aqueous coating composition has a pH value in a range of 1 to 14.

3. The aqueous coating composition according to claim 1, wherein the aqueous coating composition comprises the metal particles in amounts of 30 to 95 wt. %, based on the aqueous coating composition.

4. The aqueous coating composition according to claim 1, wherein the metal particles comprise iron, nickel, chromium, magnesium, aluminum, zinc, mixtures thereof, and/or alloys thereof.

5. The aqueous coating composition according to claim 4, wherein the metal particles comprise at least one of zinc, zinc alloys, and/or mixtures thereof.

6. The aqueous coating composition according to claim 1, wherein the silicate of the silane-modified silicate comprises a water glass.

7. The aqueous coating composition according to claim 6, wherein the water glass comprises lithium water glass, sodium water glass, potassium water glass, and/or mixtures thereof.

8. The aqueous coating composition according to claim 1, wherein the silane of the silane-modified silicate comprises epoxy-functional silanes, phenoxy-functional silanes, vinyl-functional silanes, amino-functional silanes, and/or mixtures thereof.

9. The aqueous coating composition according to claim 1, wherein the aqueous coating composition comprises the silicate-based binding agent in amounts of 1 to 30 wt. %, based on the aqueous coating composition.

10. The aqueous coating composition according claim 1, wherein the aqueous coating composition comprises water in amounts of at least 3 wt. %, based on the aqueous coating composition.

11. A coating, the coating comprising the aqueous coating composition according to claim 1.

12. The coating according to claim 11, wherein the coating comprises a layer thickness in a range of 1 to 150 μm.

13. A substrate coated with the aqueous coating composition according to claim 1.

14. The substrate according to claim 13, wherein the aqueous coating composition is coated onto the substate with thickness in a range of 1 to 150 μm.

15. A method of using the aqueous coating composition according to claim 1, the method comprising producing a corrosion protection coating using the aqueous coating composition.

16. The method according to claim 15, wherein the corrosion protection coating comprises a cathodic corrosion protection coating.

17. A method of coating a substrate, the method comprising applying the aqueous coating composition according to claim 1 on the substrate.

18. The method according to claim 17, further comprising drying the aqueous coating composition applied to the substrate.

19. A method for producing the aqueous coating composition according to claim 1, the method comprising hydrolyzing the silane in the presence of the silicate with the basic pH being equal to or greater than 8.

20. A method for coating a substrate, the method comprising applying an aqueous coating composition on the substrate, wherein the aqueous coating composition comprises at least 30 wt. % metal particles, based on the aqueous coating composition, and a silicate-based binding agent comprising a silane-modified silicate obtained by hydrolysis of a silane in the presence of a silicate at a basic pH.
